(19) United States
(12) Patent Application Publication
(10) Pub. No.: US 2025/0386768 A1
(43) Pub. Date: Dec. 25, 2025

(54) SERIES-PARALLEL HYBRID POWER COTTON PICKER AND CONTROL METHOD

(71) Applicant: JIANGSU UNIVERSITY, Zhenjiang (CN)

(72) Inventors: Lizhang XU, Zhenjiang (CN); Kongzhen ZHANG, Zhenjiang (CN); Zhihao ZHU, Zhenjiang (CN); Li QUAN, Zhenjiang (CN); Weijun JIANG, Zhenjiang (CN); Zengliang ZHAO, Zhenjiang (CN); Maolin SHI, Zhenjiang (CN)

(73) Assignee: JIANGSU UNIVERSITY, Zhenjiang (CN)

(21) Appl. No.: 18/871,494

(22) PCT Filed: Jul. 2, 2024
(86) PCT No.: PCT/CN2024/103052

§ 371 Date: Dec. 4, 2024

(30) Foreign Application Priority Data
Jun. 24, 2024 (CN) 202410819040.2

(51) Int. Cl. A01D 69/02; A01D 46/08; A01D 46/10; A01D 59/02; B60K 6/44

(52) U.S. Cl. CPC A01D 69/025; A01D 46/085; A01D 46/10; A01D 59/02; B60K 6/44; B60Y 2200/222; B60Y 2200/92

(57) ABSTRACT

A series-parallel hybrid power cotton picker includes a series-parallel hybrid power system; the series-parallel hybrid system includes an engine, a gearbox, a coupling device, a differential, a generator, battery, a main controller, a walking motor controller, a picking motor controller, a fan motor controller, a packing motor controller, a cotton collection motor controller, and a conveyor motor controller; the engine can transmit the power to the coupling device through the gearbox, and the coupling device couples the power of the engine and the walking motor, and then transmits the power to the wheels through the differential. The present disclosure achieves mechanical decoupling between the various working systems of the cotton picker through distributed electric drive, solving the problems of multiple components, long paths, and inability to adjust operating parameters in real time in traditional cotton picker transmission systems.

### CROSS REFERENCE TO THE RELATED APPLICATIONS

This application is the national phase entry of International Application No. PCT/CN2024/103052, filed on Jul. 2, 2024, which is based upon and claims priority to Chinese Patent Application No. 202410819040.2, filed on Jun. 24, 2024, the entire contents of which are incorporated herein by reference.

### TECHNICAL FIELD

The present disclosure belongs to the field of agricultural machinery electromechanical hybrid power technology, and particularly relates to a series-parallel hybrid power cotton picker and the control method.

### BACKGROUND

With the improvement of agricultural mechanization level, energy consumption and environmental pollution have become increasingly prominent issues. On a global scale, countries are increasingly emphasizing energy conservation, emission reduction, and ecological civilization construction, and the agricultural sector is no exception. In order to meet the requirements of ecology, energy conservation, and environmental protection, promoting the development and application of green power agricultural machinery is becoming increasingly urgent.

There are many drawbacks to traditional fuel powered cotton picker, including high fuel costs, high emissions pollution, and black smoke emissions; moreover, traditional cotton pickers use diesel engines and mechanical transmission to drive components such as picking devices, pneumatic conveying devices, packing devices, and walking devices. The transmission system has many components and long paths, and the operating parameters cannot be adjusted in real time, resulting in unstable machine performance and serious energy waste at low loads; however, and pure electric cotton harvesters have the disadvantages of short range and high cost, as well as the risk of fire, high danger factor, serious efficiency decline in cold regions, and high cost of battery replacement. Therefore, traditional cotton picker has problems such as fuel consumption, high pollution, severe transmission power loss, and low energy utilization efficiency.

### SUMMARY

In response to the above technical problems, the present disclosure provides a series-parallel hybrid power cotton picker that solves at least one of the above problems, with low fuel consumption, low pollution, low transmission power loss, and high energy utilization efficiency.

The present disclosure also provides a control method for the series-parallel hybrid power cotton picker, achieving a balance between the range and energy saving of the whole machine, and switching between parking mode, electric vehicle (EV) pure electric drive mode, hybrid electric vehicle (HEV) hybrid drive mode, braking mode, and plug-in mode through the application of a series-parallel hybrid power system. Thus the present disclosure can improve the fuel economy and dynamic performance of the entire vehicle.

Note that the recording of the purposes does not hinder the existence of other purposes. One approach of the disclosure does not require achieving all of the above objectives. Objectives other than the Objectives mentioned above can be extracted from the description, drawings, and claims.

The disclosure achieves the aforementioned technical objectives through the following technical means.

The series-parallel hybrid power cotton picker, including the series-parallel hybrid power system; the series-parallel hybrid power system includes an engine, a gearbox, a coupling device, a differential, a generator, a battery, a main controller, a walking motor controller, a picking motor controller, a fan motor controller, a packing motor controller, a cotton collection motor controller, and a conveyor motor controller; the engine and the battery are used for outputting power; the generator is used to convert the mechanical energy of the engine into electrical energy to charge the battery; the battery is connected to the walking motor controller to distribute electrical energy to the walking motor controller and controls the walking motor to drive walking device to move; the battery is connected to the picking motor controller to distribute electrical energy to the picking motor controller, and the picking motor controller controls the picking motor to drive the picking device for picking; the battery is connected to the fan motor controller to distribute electrical energy to the fan motor controller, and the fan motor controller controls the fan motor to drive the pneumatic conveying device for air supply; the battery is connected to the packing motor controller, and the packing motor controller distributes electrical energy to control a packing motor to drive a packing device for packing; the battery is connected to the cotton collection motor controller, and the cotton collection motor controller distributes electrical energy to the cotton collection motor controller to control the motor for driving a striking roller to feed cotton into a cotton collection box; the battery is connected to the conveyor motor controller, and the conveyor motor controller distributes electrical energy to the conveyor motor controller to control a hydraulic pump motor for driving the wing plate of the cotton rack; the engine is connected to the gearbox, and the gearbox is connected to the coupling device, and the coupling device is connected to the walking motor. The engine can transmit power to the coupling device through the gearbox, and the coupling device couples the power of the engine and the walking motor, and then transmits the power to the wheels through the differential; the main controller is respectively connected to the battery, the walking motor controller, the picking motor controller, the fan motor controller, the packing motor controller, the cotton collection motor controller, and the conveyor motor controller.

In the above solution, the walking motor controller includes a front axle motor controller and a rear axle motor controller; the walking motor includes a front axle motor and a rear axle motor; the front axle motor controller is used to control the front axle motor to drive front wheels to move; the rear axle motor controller is used to control the rear axle motor to drive rear wheels to move.

In the above solution, the picking device includes a picking drum and a cotton removal drum; the picking motor is connected to a picking transmission shaft, and the picking transmission shaft is connected to the picking drum and the cotton removal drum through a transmission gear set; the picking motor drives the picking transmission shaft, and then transmits the power to the picking drum and the cotton removal drum through the transmission gear set 15-a.

In the above solution, the fan in the pneumatic conveying device is connected to the fan motor and driven separately by the fan motor.

In the above solution, the striking roller of the feeding system in the cotton collection box is connected to a motor and driven separately by the motor.

In the above solution, a film feeding roller and a transmission belt of the laminating device in the packing device share the packing motor; the film feeding roller is connected to the packing motor and directly driven by the packing motor; the transmission belt is connected to the packing motor through a belt and driven by the packing motor through the belt.

In the above solution, the battery is connected to the main controller through a step-down direct current to direct current (DC/DC) converter; after being stepped down by the DC/DC converter, the battery supplies the power to the main control of the motor.

In the above solution, a clutch is installed in front of the generator, and controls the power input to the generator.

In the above solution, an inverter is installed between the generator and the battery.

In the above solution, the series-parallel hybrid power system includes parking mode A, EV pure electric drive mode B, HEV hybrid drive mode C, braking mode D, and plug-in mode E, and can switch between different modes.

In the above solution, in the EV pure electric drive mode B, the power is only provided to the walking motor through the battery.

In the above solution, in the parking mode A, the whole machine is parked in place.

In the above solution, in the HEV hybrid drive mode C, when pure electric drive cannot meet the target power, the battery and the engine work simultaneously. The power of the engine and the battery driven walking motor is coupled through the coupling device and drives the wheels to walk through the differential. At the same time, the clutch cuts off the power entering the generator and stops charging the battery.

Furthermore, in the HEV hybrid drive mode C, when pure electric drive can meet the target power, the engine is connected to the generator to charge the battery.

In the above solution, in the braking mode D, the wheels charge the battery in reverse through the walking motor.

In the above solution, in the plug-in mode E, the series-parallel hybrid cotton picker is powered by an external power source to charge the battery.

A control method for the series-parallel hybrid cotton picker, including the following steps:
distributing the electrical energy by the battery of the series-parallel hybrid power system to the walking motor controller to control the walking motor and drive the walking device to move;
distributing the electrical energy by the picking motor controller to control the picking drum and the cotton removal drum of the picking device driven by the picking motor for picking; distributing the electrical energy to the fan motor controller to control the fan motor to drive the pneumatic conveying device separately for air supply; distributing the electrical energy to the packing motor controller to control the packing motor to drive the film feeding roller and the transmission belt of the packing device for packing; distributing the electrical energy to the cotton collection motor controller to control the motor to drive the striking roller separately to feed cotton into the cotton collection box; distributing the electrical energy to the conveyor motor controller to control the hydraulic pump motor to drive the wing plate of the cotton rack; adjusting the speed of the walking motor, the picking motor, the fan motor, the packing motor, the cotton collecting motor, and the conveying motor through the walking motor controller, the picking motor controller, the fan motor controller, the packing motor, the motor, and the hydraulic pump motor controller in the main controller.

The above plan also includes the following steps:
in the EV pure electric drive mode B of the series-parallel hybrid power system, providing power to the walking motor only by the battery;
in the HEV hybrid drive mode C of the series-parallel hybrid power system, when pure electric drive cannot meet the target power, working simultaneously are the battery and the engine; coupling the output power of the engine and walking motor driven by the battery by a coupling device and driving the wheels to walk by the differential, and cutting off the power by the clutch and stopping the engine charging the battery at the same time;
in the HEV hybrid drive mode C of the series-parallel hybrid power system, when pure electric drive can meet the target power, being connected to the generator to charge the battery by the engine in the series-parallel hybrid power system;
in the braking mode D of the series-parallel hybrid power system, charging the battery in reverse by the wheels through the walking motor;
in the plug-in mode E of the series-parallel hybrid power system, charging the battery of the cotton picker by an external power source in the series-parallel hybrid power system.

The above solution also includes the following control steps of the series-parallel hybrid power system:
when the cotton picker starts, switching from the parking mode A to the EV pure electric drive mode B, with the drive torque Tₜ>0 and the braking torque T_{brk}=0;
when the cotton picker decelerates, switching from the EV pure electric drive mode B to the brake mode D, with the vehicle speed νᵥₑₕ>0, the drive torque Tₜ=0 and the braking torque T_{brk}>0;
when the cotton picker accelerates, switching from the brake mode D to the EV pure electric drive mode B, with the vehicle speed νᵥₑₕ>0, the drive torque Tₜ>0 and the braking torque T_{brk}=0;
when the cotton picker decelerates, switching from the HEV hybrid drive mode C to the EV pure electric drive mode B, with the vehicle speed νᵥₑₕ<ν_{EV} the pure electric mode speed threshold, the drive torque Tₜ>0, the braking torque T_{brk}=0, and the battery state of charge (SOC)>the minimum battery capacity;
when the cotton picker continues to accelerate, switching from the EV pure electric drive mode B to the HEV hybrid drive mode C, with the vehicle speed νᵥₑₕ>ν_{EV} the vehicle speed threshold in pure electric mode, the drive torque Tₜ>0 and the braking torque T_{brk}=0;
when the cotton picker wheel drives the generator to charge the battery, with the vehicle speed νᵥₑₕ>0, the drive torque Tₜ=0, the braking torque T_{brk}≤T_{reg} the maximum regenerative braking torque of the motor, and the battery state of charge (SOC)<the maximum battery capacity;
when the cotton picker accelerates, switching from the brake mode D to the HEV hybrid drive mode C, with the vehicle speed νᵥₑₕ>0, the drive torque Tₜ>0 and the braking torque T_{brk}>0;
when the cotton picker decelerates, switching from the HEV hybrid drive mode C to the braking mode D, with the vehicle speed νᵥₑₕ>0, the drive torque Tₜ=0 and the braking torque T_{brk}>0;
when the cotton picker decelerates to a stop, switching from the brake mode D to the parking mode A, with the vehicle speed νᵥₑₕ=0, the drive torque Tₜ=0 and the braking torque T_{brk}>0;

Compared with the existing technology, the beneficial effects of the disclosure are:
the series-parallel hybrid power cotton picker of the disclosure has low fuel consumption, minimal pollution, low transmission power loss, and high energy utilization efficiency, making the series-parallel hybrid power cotton picker an efficient, energy-saving, and low-cost cotton picker.

The disclosure achieves mechanical decoupling in the various operating systems of the cotton picker through distributed electric drive, solving the problems of multiple components, long paths, and inability to adjust operating parameters in real time in traditional cotton picker transmission systems. By removing transmission belts, belts, etc., the operating system and the power system are simplified. The electric motor is an independent system from the engine, making maintenance and adjustment easier.

The series-parallel hybrid power cotton picker of the disclosure has the advantages of flexible layout of the operating system structure and high energy utilization efficiency; at the same time, the application of batteries and generators can reduce the fuel consumption and carbon emissions of the entire machine, and improve environmental friendliness; through the application of the series-parallel hybrid power systems, the range and energy efficiency of the entire vehicle can be balanced, and mode switching between parking mode, EV pure electric drive mode, HEV hybrid drive mode, braking mode, and plug-in mode can be achieved, improving the fuel economy and dynamic performance of the vehicle.

Note that the recording of these effects does not hinder the existence of other effects. One embodiment of the disclosure does not necessarily have to have all of the aforementioned effects. The effects beyond the above can be clearly seen and extracted from the description, drawings, claims, and other records.

### BRIEF DESCRIPTION OF THE DRAWINGS

FIG. 1 is a topology diagram of a series-parallel hybrid power cotton picker according to an embodiment of the disclosure;

FIG. 2 is a partial cross-sectional view of the side of the series-parallel hybrid power cotton picker according to an embodiment of the disclosure;

FIG. 3 is a top view of the picking process of the series-parallel hybrid power cotton picker according to an embodiment of the disclosure;

FIG. 4 is a schematic diagram of pneumatic conveying of the series-parallel hybrid power cotton picker according to an embodiment of the disclosure;

FIG. 5 is a side view of the packing of the series-parallel hybrid power cotton picker according to an embodiment of the disclosure;

FIG. 6 is a top view of the chassis of the series-parallel hybrid power cotton picker according to an embodiment of the disclosure;

FIG. 7 is a schematic diagram of the operation mode switching of the series-parallel hybrid power cotton picker according to an embodiment of the disclosure;

FIG. 8 is a schematic diagram of the power flow in the EV pure electric drive mode of the series-parallel hybrid power cotton picker according to the disclosure;

FIG. 9 is a schematic diagram of the power flow in the HEV hybrid drive mode of the series-parallel hybrid power cotton picker according to the disclosure;

FIG. 10 is a schematic diagram of the braking mode power flow of the series-parallel hybrid power cotton picker according to the disclosure;

FIG. 11 is a schematic diagram of the operation mode switching of the series-parallel hybrid power cotton picker according to the disclosure.

In the drawings, 10. Operating system, 11. Main Controller, 11-a. Front Axle Motor Controller, 11-b. Rear Axle Motor Controller, 11-c. Picking Motor Controller, 11-e. Fan Motor Controller, 11-f. Packing Motor Controller, 11-g. Cotton Collection Motor Controller, 12. Step-Down DC/DC Converter, 13. Front Axle Motor, 14. Rear Axle Motor, 15. Picking Motor, 15-a. Transmission Gear Set, 15-b. Picking Transmission Shaft, 16. Fan Motor, 17. Packing Motor, 17-a. Belt, 18. Hydraulic Pump Motor, 18-a. Motor, 19. Hydraulic System, 20. Power System, 21. Engine, 22.Gearbox, 23-a. First Coupling Device, 23-b. Second Coupling Device, 24-a. First Differentia, 24-b. Second Differential, 25-a. Front Wheel, 25-b. Rear Wheel, 25-c. Front Drive Shaft, 25-d. Rear Drive Shaft, 26. Generator, 26-a. Clutch, 27. Inverter, 28. Battery, 29. External Power Supply, 30. Walking Device, 40. Picking Device, 41. Crop Support Device, 42. Picking Drum, 43. Cotton Removal Drum, 50. Pneumatic Conveying System, 51. Air Distribution Duct, 52. Cotton Conveying Pipe, 60. Cotton Collection Box, 61. Striking Roller, 70. Packing Device, 71. Film Feeding Roller, 72. Transmission Belt, 80. Cotton Support Frame

### DETAILED DESCRIPTION OF THE EMBODIMENTS

The embodiments of the disclosure are described in detail below, and examples of the embodiments are shown in the accompanying drawings, where the same or similar reference numerals throughout represent the same or similar elements or elements with the same or similar functions. The embodiments described below with reference to the accompanying drawings are exemplary and intended to be used to illustrate the disclosure, and should not be construed as limiting the disclosure.

In the description of the disclosure, the terms “center”, “longitudinal”, “transverse”, “length”, “width”, “thickness”, “front”, “back”, “left”, “right”, “up”, “down”, “axial”, “radial”, “vertical”, “horizontal”, “inside”, “outside” and other directional or positional relationships are based on the directional or positional relationships shown in the accompanying drawings, only for the convenience of describing the disclosure and simplifying the description, and do not indicate or imply that the device or element referred to must have a specific orientation, be constructed and operated in a specific orientation, and therefore cannot be understood as a limitation of the disclosure. In addition, the terms “first” and “second” are only used for descriptive purposes and cannot be understood as indicating or implying relative importance or implying the number of technical features indicated. Thus, the features limited to “first” and “second” may explicitly or implicitly include one or more of these features. In the description of the disclosure, “multiple” means two or more, unless otherwise specifically limited.

In the disclosure, unless otherwise specified and limited, terms such as “installation”, “connection”, “connection”, and “fixation” should be broadly understood, for example, connections can be fixed connections, detachable connections, or integral connections; connections can be a mechanical connection or an electrical connection; connections can be directly connected, indirectly connected through an intermediate medium, or connected internally between two components. For ordinary technical personnel in this field, the specific meanings of the above terms in the disclosure can be understood according to the specific situation.

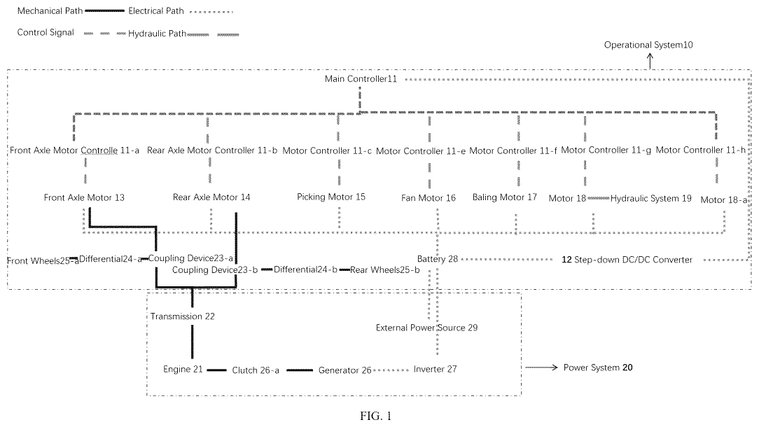

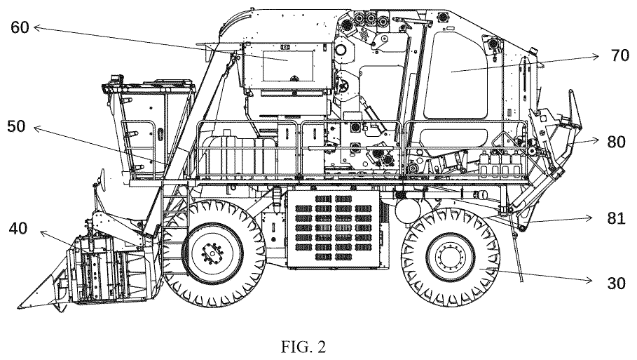

As shown in FIG. 1 and FIG. 2, a preferred embodiment of the series-parallel hybrid power cotton picker of the present disclosure includes a series-parallel hybrid power system 20 and an operating system. The series-parallel hybrid power system 20 includes an engine 21, a gearbox 22, coupling devices, a differential, a generator 26, an inverter 27, a battery 28, a main controller 11, traction motor controllers, a picking motor controller 11-c, a fan motor controller 11-e, a packing motor controller 11-f, a cotton collection motor controller 11-g, a conveyor motor controller 11-h, a step-down DC/DC converter 12, and multiple motors. An operating system 10 includes a walking device 30, a picking device 40, a pneumatic conveying system 50, a cotton collection box 60, a packing device 70, and a cotton support frame 80.

As shown in FIG. 1, in a specific embodiment of the present disclosure, the coupling device includes a first coupling device 23-a and a second coupling device 23-b, and the differential includes a first differential 24-a and a second differential 24-a; the motor includes a walking motor and a working motor. The walking motor includes a front axle motor 13 and a rear axle motor 14. The walking motor controller includes a front axle motor controller 11-a and a rear axle motor controller 11-b; the working motors include a picking motor 15, a fan motor 16, a packing motor 17, a motor 18-a, and a hydraulic pump motor 18; the engine 21, the gearbox 22, the first coupling device 23-a, the second coupling device 23-b, the first differential 24-a, the second differential 24-a, and the generator 26 are connected through a mechanical path. The generator 21, the inverter 27, the battery 28, the main controller 11, the step-down DC/DC converter 12, the front axle motor 13, the rear axle motor 14, the picking motor 15, the fan motor 16, the packing motor 17, the motor 18-a, and the hydraulic pump motor 18 are connected to the battery 28 through wires. The main controller 11, the picking motor controller 11-c, the fan motor controller 11-e, the packing motor controller 11-f, the cotton collection motor controller 11-g, and the conveyor motor controller 11-h are connected through control signals. The motor 18-a of the wing plate in the cotton support frame 80 is connected to a hydraulic system through a hydraulic path.

The engine 21 and battery 28 are used for outputting power; the generator 26 is used to convert the mechanical energy of the engine 21 into electrical energy to charge battery 28; the battery 28 is connected to the walking motor controller, and the walking motor controller distributes electrical energy to control the walking motor to drive the walking device to move. The front axle motor controller 11-a is used to control the front axle motor to drive front wheels 25-a to move; the rear axle motor controller 11-b is used to control the rear axle motor to drive rear wheels 25-b to move; the battery 28 is connected to the picking motor controller 11-c to distribute electrical energy to the picking motor controller 11-c, and the picking motor controller 11-c controls the picking motor 15 to drive the picking device for picking; the battery 28 is connected to the fan motor controller 11-e to distribute electrical energy to the fan motor controller 11-e, and the fan motor controller 11-e controls the fan motor 16 to drive the pneumatic conveying device 50 for air supply; the battery 28 is connected to the packing motor controller 11-f, and distributes electrical energy to the packing motor controller 11-f to control the packing motor 17 for driving a packing device for packing; the battery 28 is connected to the cotton collection motor controller 11-g, and the cotton collection motor controller 11-g distributes electrical energy to the cotton collection motor controller 11-g and controls the motor 18-a to drive a striking roller 61 in the feeding system to feed cotton into the cotton collection box 60; the battery 28 is connected to the conveyor motor controller 11-h, and distributes electrical energy to the conveyor motor controller 11-h to control the hydraulic pump motor 18 for driving the wing plate of the cotton support frame 80 to lower and unload the cotton in the cotton packing warehouse; the engine 21 is connected to the gearbox 22, and the gearbox 22 is connected to a coupling device. The coupling device is connected to the walking motor, and the engine 21 can transmit power to the coupling device through the gearbox 22. The coupling device couples the power of the engine 21 and the walking motor, and then transmits the power to the wheels through a differential; the main controller 11 is respectively connected to the battery 28, the walking motor controller, the picking motor controller 11-c, the fan motor controller 11-e, the packing motor controller 11-f, the cotton collection motor controller 11-g, and the conveyor motor controller 11-h.

In order to ensure that the picking device 40 and the pneumatic conveying device 50 can maintain a relatively constant speed under large load fluctuations during the operation process, the motor main controller 11 can adjust the operation parameters in real time according to the operation situation to ensure the stable operation of the cotton picker. The present disclosure adopts distributed electric drive technology, which achieves mechanical decoupling between various working components and improves work efficiency.

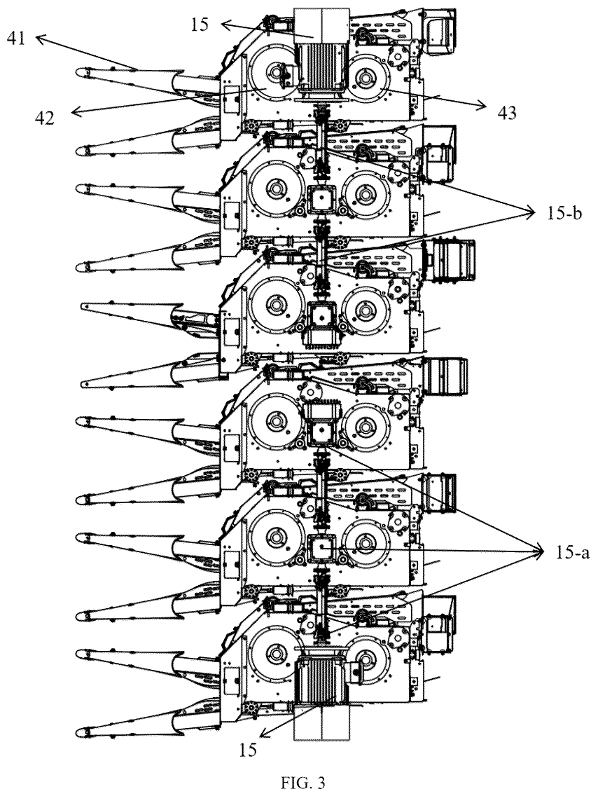

As shown in FIG. 2 and FIG. 3, in one embodiment of the present disclosure, the picking device 40 is installed at the lower front of the cotton picker, spanning both sides of the entire width. The picking device 40 includes a straw feeder, a grid plate, a picking ingot, a picking drum 42, a cotton removal drum 43, a guide groove, cleaning solution, a picking motor, etc. The picking motor 15 is connected to a picking transmission shaft 15-b, and the picking transmission shaft is connected to the picking drum 42 and the cotton removal drum 43 through the transmission gear set 15-a; the picking motor 15 drives the picking transmission shaft 15-b, and then transmits the power to the picking drum 42 and the cotton removal drum 43 through the transmission gear set 15-a. The picking drum 42 is equipped with the picking motor 15, and the cotton removal drum 43 is driven by the picking motor 15 through the transmission gear set 15-a. In a specific embodiment of the present disclosure, the picking motor 15 is installed above the picking drum 42 and the cotton removal drum 43, and the picking motor 15 controls three picking heads through the transmission gear set 15-a and the picking transmission shaft 15-b. In addition, the series-parallel hybrid cotton picker can adjust the speed of the picking motor 15 according to different working conditions, thereby reducing energy waste and improving work performance.

In a specific embodiment of the present disclosure, it is preferred that the picking motor 15 is installed at the front end of the cotton picker, and the installation method is conducive to equipping the picking part with an electric picking spindle, but the installation method will cause the center of gravity of the cotton picker to move forward. In order to balance the center of gravity of the cotton picker, a battery 28 is installed in the middle and rear sections of the cotton picker, and the installation method can stabilize the posture of the cotton picker.

The output shaft speed of the cotton removal drum 43 used for cotton removal is reduced by the transmission gear set 15-a, and the transmission gear set 15-a makes it possible for the series-parallel hybrid power cotton picker to obtain high torque at low speeds. In this way, the driving device of the cotton removal drum is jointly driven by the picking motor 15, the transmission gear set 15-a, and the driving device generate the power to drive cotton removal.

The working process of the picking device: the picking drum 42 is equipped with self rotating steel fingers with hooked teeth for picking. When the picking drum 42 rotates, the picking spindle enters the plant that is squeezed in the picking area. The inclined hooked teeth on the picking spindle catch the seed cotton and pull it out of the cotton peach, rotating inward. The cotton is swept down by the cotton removal drums arranged in front and behind the picking drum 42. The rotation direction of the cotton removal drum 43 is opposite to the rotation direction of the picking spindle. An air distribution duct 51 is connected between the picking drum 42 and the cotton removal drum 43, and the air in the air distribution duct 51 causes the seed cotton to fall off the cotton removal drum 43 at a very high speed and enter a cotton conveying pipe 52.

However, the traditional horizontal pick spindle cotton-picking device is a complex mechanical structure system, and the speed of the picking device is stable during actual harvesting operations. Therefore, when encountering high-density cotton plants, blockage is a common phenomenon that affects harvesting efficiency. When the outflow is large, increasing the speed of the picking motor can achieve stepless speed regulation function to reduce the possibility of system blockage.

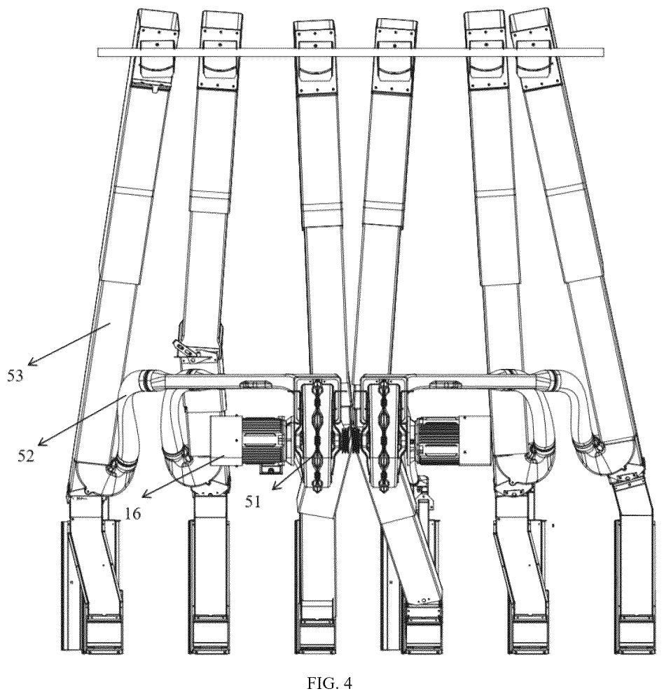

As shown in FIG. 4, the pneumatic conveying device 50 of the cotton picker includes a fan, the air distribution duct 51, a cotton conveying duct 52, and the fan motor 16. The fan is installed below the cotton picker, and the right side of the fan is driven by the fan motor 16. The high-speed rotation of the fan forms an airflow, and the airflow has two directions. One is to enter the air distribution duct 51, and the end of the air distribution duct 51 is located above the middle of the picking drum 42 and the cotton removal drum 43. Then, the cotton detached from the cotton removal drum 43 is blown backwards to the cotton conveying pipe 52; another direction of the airflow is the cotton conveying pipe 52, and the cotton conveying pipe 52 will transport the cotton blown out from the cotton removal drum 43 to the cotton collection box 60, and the cotton picker will temporarily store the cotton in the cotton collection box 60.

The fan driven by the fan motor 16 is integrated with the fan motor controller 11-e to achieve automation and intelligent control, and the technology facilitates the automatic start stop, speed adjustment, fault detection and other functions of the fan to improve the operational efficiency and reliability of the cotton picker. The driver can adjust the fan controller 11-e to flexibly control the motor speed and air output by observing the input amount of cotton, in order to adapt to different working conditions and requirements.

The fan in the pneumatic conveying device 50 is connected to the fan motor 16 and driven separately by the fan motor 16.

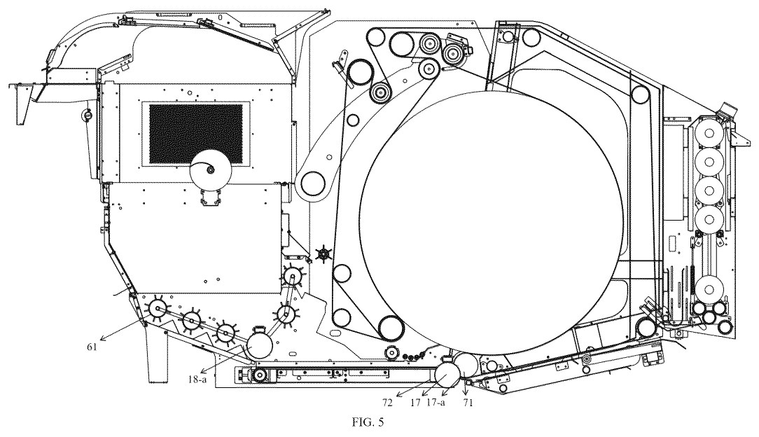

As shown in FIG. 5, the cotton collection box 60 is located in the middle upper part of the cotton-picking machine, behind the outlet of the cotton conveying pipe 52 of the conveying system. The conveying feeding system is located below the cotton collection box 60 and above the chassis. The striking roller 61 in the conveying feeding system is driven separately by the motor 18-a.

The function of the cotton collection box 60 is to store cotton transported by the fan. When the cotton reaches a certain height, it can be crushed by the striking roller 61 of the feeding system to evenly feed the cotton into the packing device.

As shown in FIG. 5, a film feeding roller 71 and a transmission belt 72 of the laminating device in the packing device 70 share the packing motor 17; the film feeding roller 71 is connected to the packing motor 17 and is directly driven by the packing motor 17; the transmission belt 72 is connected to the packing motor 17 through a belt 17-a and driven by the packing motor 17 through the belt 17-a.

The working process of the packing device 70: the packing device 70 is located behind the cotton-picking machine, behind the feeding system. When the size of the cotton bales reaches the set value, the packing motor 17 in the packing device 70 directly drives the film feeding roller 71, and the transmission belt 72 is driven by the packing motor 17 through the belt. The transmission belt 72 smoothly deliver the cotton into the warehouse, and the cotton is wound into shape. After the cotton collecting box is emptied, and the film feeding roller stops working, the rear box is opened to transport the cotton bag to the cotton support frame.

The battery 28 is connected to the main controller 11 through a step-down DC/DC converter 12; after being stepped down by the step-down DC/DC converter 12, the battery 28 supplies power to the motor main controller 11.

There is a clutch 26-a in front of the generator 26, and the clutch 26-a can complete the power on/off of the engine 21 to the generator 26.

The inverter 27 is provided between the generator 26 and the battery 28.

The walking device 30 is installed on the lower chassis of the cotton picker. The walking device has a pair of tires at the front and rear of the cotton picker, and the rear wheels can provide steering. The front and the rear wheels can make the cotton picker move forward or backward.

In a specific embodiment of the present disclosure, the motor main controller 11 is located at the front end of the cotton picker. The motor main controller 11 controls the front axle motor controller 11-a, the rear axle motor controller 11-b, the picking motor controller 11-c for operating the picking spindle, the motor controller 11-h for conveying cotton in the cotton collection box, the motor controller 11-f for packing cotton, and the hydraulic pump motor controller 11-g for controlling the wing plate.

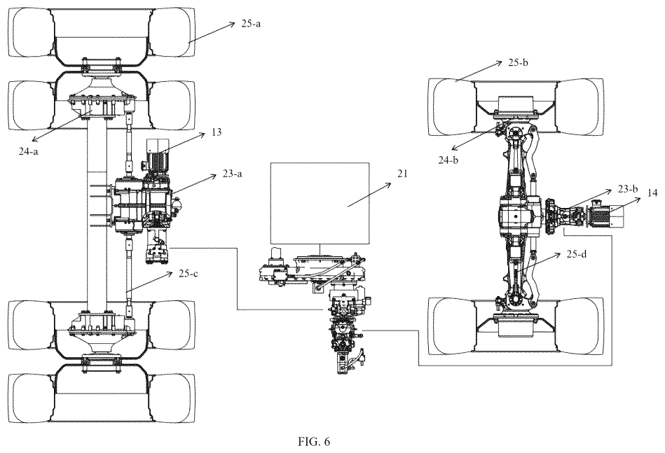

As shown in FIG. 6, the engine 21 is located on the left side of the cotton picker chassis, below the cotton collection box 60, and the generator 26 is located on the right side of the engine 21. The Generator 26 is connected to the engine 21 and is powered by the engine 21, and the electrical energy generated by the Generator 26 is stored in the battery 28 through the inverter 27. The power generated by the engine 21 through the gearbox 22 is coupled with the power of the front axle motor 13 and the rear axle motor 14 driven by battery 28 through a planetary gear coupling device. The first coupling device 23-a and the second coupling device 23-b are respectively connected to the first differential 24-a and the second differential 24-b, and the power is transmitted to the front wheels 25-a and the rear wheels 25-b through front drive shafts 25-c and rear drive shafts 25-d.

The hydraulic pump in the traditional fuel powered cotton picker walking device is mainly used to drive the hydraulic motor, providing power to enable the cotton picker to travel and turn. The hydraulic system requires regular replacement of hydraulic oil, maintenance of hydraulic pipelines and components, with high maintenance costs. Moreover, the high-pressure fluid in the hydraulic systems may pose a risk of leakage and splashing, posing a potential threat to the safety of operators. In contrast, the motor-driven pumps have lower maintenance costs and only require regular inspection and maintenance of the motor and the electrical control system; and the electric pump does not involve high-pressure liquids, so the electric pump is safer than the hydraulic pump; the Electric pumps only require power and pipelines, making the system structure simpler and reducing the difficulty of maintenance and troubleshooting.

The hydraulic oil in the hydraulic system generates heat and energy loss, while the energy conversion efficiency of electric pumps is higher, and the electric pumps can achieve better energy conservation, environmental protection, operational efficiency, and energy utilization efficiency.

The following is the cotton-picking process of the series-parallel hybrid cotton picker: the seed cotton collected by the cotton-picking head is sent to the cotton collection box 60 through the pneumatic conveying device 50, and the cotton is evenly distributed by compacting the auger. When the cotton warehouse is full, the striking roller 61 breaks the cotton briquettes to feed the cotton evenly, and the packing motor 17 directly drives the film feeding roller to drive the belt 17-a to rotate and wind the cotton into shape. After the cotton collection box 60 is cleared, the film feeding roller 71 stops working, and the cotton bale size reaches the set value. The packing motor 17 drives the packing system to start and complete the film wrapping. The rear box is opened and packed to the cotton support frame 80, and the driver can pack to the designated position or immediately place on the ground as required.

The series-parallel hybrid power cotton picker of the present disclosure utilizes electric motors to reduce the load on the fuel engine, thereby reducing the wear and failure risk of the fuel engine. The electric motors can extend the lifespan of fuel engines and improve the reliability and durability of the entire system.

The series-parallel hybrid power cotton picker of the present disclosure utilizes the high torque and fast response characteristics of the motor to provide additional power and performance for the cotton picker, and the Electric motors can provide auxiliary power when higher power is required, improving the acceleration performance and the operational efficiency.

The series-parallel hybrid power cotton picker of the present disclosure utilizes the use of electric motors to reduce dependence on the fuel, thereby reducing the energy consumption and the carbon emissions. The Electric motors have high efficiency at low loads and start-up, while fuel engines can provide the additional power at high loads. The combination can achieve higher fuel efficiency, improve operational efficiency, and reduce environmental pollution.

In addition, the engine 21 and the battery 28 are the energy sources of the entire machine, combined with the gearbox 22, the coupling device, the differential, the generator 26, the inverter 27, the battery 28 and other components to form the power system of the entire machine.

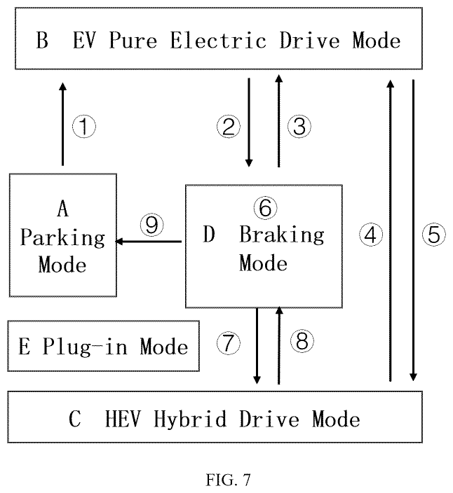

As shown in FIG. 7, the series-parallel hybrid power system 20 includes the parking mode A, the EV pure electric drive mode B, the HEV hybrid drive mode C, the braking mode D, the and plug-in mode E, and the series-parallel hybrid power system can be switched between different modes. In the EV pure electric drive mode B, the walking motor is powered only by battery 28, and the battery 28 provides electrical energy to multiple motors and the main controller 11, then, the main controller 11 controls the front and rear axle controllers to achieve stepless speed regulation of the motors; In the parking mode A, the entire vehicle is parked in place. In the EV pure electric drive mode B, the battery 28 provides power to the front axle motor 13 and the rear axle motor 14, with the front axle motor 13 driving the front wheels 25-a and the rear axle motor 14 driving the rear wheels 25-b; in the HEV hybrid drive mode C, when a large amount of power is required or the battery is insufficient, or the pure electric efficiency is lower than the driving efficiency of the engine 21, the battery 28 and the engine 21 work simultaneously, and the power of the front axle motor 13 and the rear axle motor 14 driven by the engine 21 and the battery 28 is coupled to the outside through a coupling device, and the coupling device is a planetary gear coupling device, and the Clutch 26-a cuts off the power entering the generator and stops charging the battery 28, so that the power of the engine 21 and the motor 26 is fully used for the series-parallel hybrid power cotton picker to obtain maximum power. When the target power is not needed, the engine 21 connects the clutch 26-a to drive the generator 26 to charge the battery 28; in the braking mode D, when braking is required, the front wheels 25-a charge the battery 28 in reverse through the front axle motor 13; in the plug-in mode E, when the cotton picker is stopped, an external power source is connected to the cotton picker to charge power battery. Therefore, compared with traditional combine harvesters, the engine does not have to always operate at maximum horsepower, but always operates in the ideal range, and the way improves energy utilization efficiency.

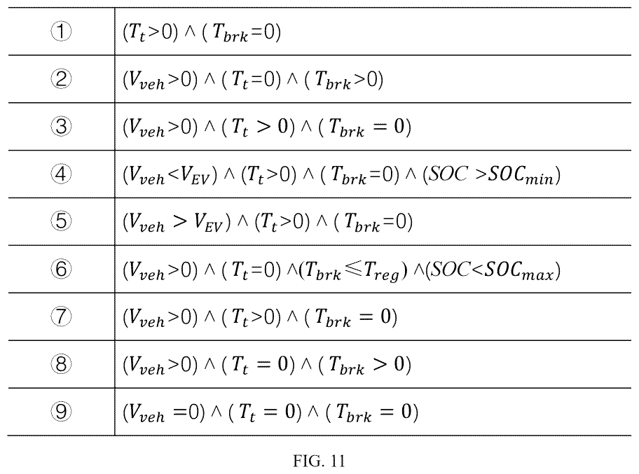

In FIG. 7, the vehicle speed νᵥₑₕ and the battery SOC represent vehicle state variables, driving torque Tₜ and braking torque T_{brk} represent control input variables, T_{reg} and ν_{EV} are respectively the maximum regenerative braking torque of the motor and the pure electric mode vehicle speed threshold, and symbols “∧” [symbol] “∨” represent logical operators “AND” and “OR”, and \textcircled{1}-\textcircled{9} are sets of switching conditions for different working modes, as shown in FIG. 11. FIG. 7 illustrates the dynamic evolution process of different working modes in the actual driving cycle, and the switching condition set \textcircled{1}-\textcircled{9} is composed of current state feedback and control input to update the driving system state and working mode, furthermore, different working modes are independent discrete events, and there is a dynamic evolution process of continuous state variables in the current mode. Therefore, switching between different working modes involves continuous variables and discrete states that interact with each other, thereby improving the fuel economy and dynamic performance of the entire vehicle.

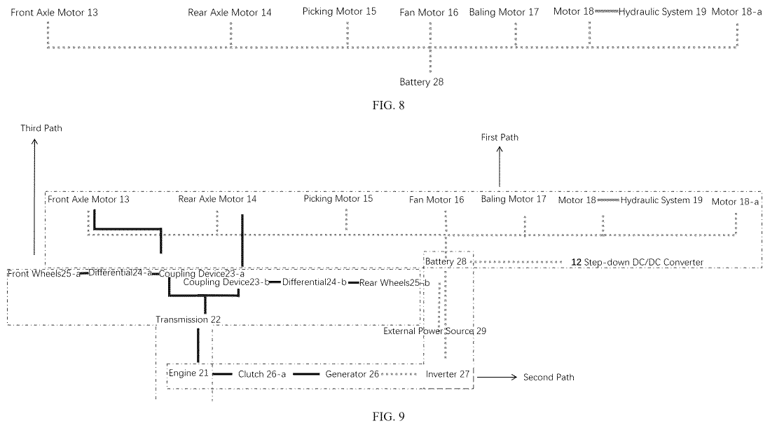

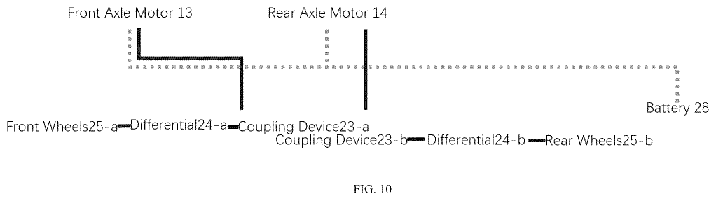

FIG. 8 to FIG. 10 illustrate the power flow of each mode in the power system of the present disclosure. Among them, the EV pure electric drive mode B power flow: the battery 28→the front axle motor 13, the rear axle motor 14, the picking motor 15, the fan motor 16, the packing motor 17, the hydraulic pump motor 18, the motor 18-a, as shown in FIG. 8. The HEV hybrid drive mode C power flow: the first path: the battery 28→the front axle motor 13, the rear axle motor 14, the picking motor 15, the fan motor 16, the packing motor 17, the hydraulic pump motor 18, the motor 18-a; the second path: the gearbox 22→the engine 21→the generator 26→the inverter 27→the battery 28; the third path: the Engine 21→the gearbox 22→the coupling device→the differential→the wheels, as shown in FIG. 9. The Braking mode D Power flow D: the front wheels, the rear wheels→the front axle motor 13, the rear axle motor 14→the battery 28, as shown in FIG. 10.

A control method for the series-parallel hybrid power cotton picker, including the following steps:
distributing by the battery 28 electrical energy to the walking motor controller to control the walking motor and drive the walking device to move; when the pure electric drive of the battery cannot meet the target power, transmitting by the engine 21 power to the coupling device through the gearbox 22, and coupling by the coupling device the power of the engine and the walking motor, and then transmitting the power to the wheels through the differential, and driving jointly by the battery 28 and the engine 21 the wheels to walk; when the pure electric drive of battery 28 can meet the target power, connecting the clutch 26-a by the engine 21 to drive the generator 26 to charge the battery 28;
distributing by the battery 28 electrical energy to the picking motor controller 11-c, to control the picking motor 15 to drive the picking drum 42 and the cotton removal drum 43 of the picking device 40 for picking; distributing by the battery 28 electrical energy to the fan motor controller 11-e, to control the fan motor 16 to independently drive the pneumatic conveying device 50 for air supply; distributing by the battery 28 electrical energy to the packing motor controller 11-f, to control the packing motor 17 to drive the film feeding roller 71 and the transmission belt 72 of the packing device 70 for packing; distributing by the battery 28 electrical energy to the cotton collection motor controller 11-g, to control the motor 18-a to independently drive the striking roller 61 in the feeding system to feed cotton into the cotton collection box 60; distributing by the battery 28 electrical energy to the conveyor motor controller 11-h, to control the hydraulic pump motor to drive the wing plate of the cotton support frame 80 to lower and unload the cotton in the cotton collection box 60;
adjusting by the main controller 11 independently the speed of the walking motor, the picking motor, the fan motor, the bagging motor, the motor 18-a, and the hydraulic pump motor through the walking motor controller, the picking motor controller 11-c, the fan motor controller 11-e, the packing motor controller 11-f, the cotton collection motor controller 11-g, and the conveyor motor controller 11-h.

As shown in FIG. 11, the control method for the series-parallel hybrid cotton picker also includes the following control steps for switching between different working modes of the series-parallel hybrid power system 20:
when the cotton picker starts, switching from the parking mode A to the EV pure electric drive mode B, with the drive torque Tₜ>0 and the braking torque T_{brk}=0;
when the cotton picker decelerates, switching from the EV pure electric drive mode B to the brake mode D, with the vehicle speed νᵥₑₕ>0, a drive torque Tₜ=0 and the braking torque T_{brk}>0;
when the cotton picker accelerates, switching from the brake mode D to the EV pure electric drive mode B, with the vehicle speed νᵥₑₕ>0, a drive torque Tₜ>0, and the braking torque T_{brk}=0;
when the cotton picker decelerates, switching from the HEV hybrid drive mode C to the EV pure electric drive mode B, with the vehicle speed νᵥₑₕ<ν_{EV} the pure electric mode speed threshold, the drive torque Tₜ>0, the braking torque T_{brk}=0, and the battery state of charge (SOC)>the minimum battery capacity;
when the cotton picker continues to accelerate, switching from the EV pure electric drive mode B to the HEV hybrid drive mode C, with the vehicle speed νᵥₑₕ>ν_{EV} the vehicle speed threshold in pure electric mode, the drive torque Tₜ>0 and the braking torque T_{brk}=0;
when the cotton picker wheel drives the generator to charge the battery, with the vehicle speed νᵥₑₕ>0, the drive torque Tₜ=0, the braking torque T_{brk}≤T_{reg} the maximum regenerative braking torque of the motor, and the battery state of charge (SOC)<maximum battery capacity;
when the cotton picker accelerates, switching from the brake mode D to the HEV hybrid drive mode C, with the vehicle speed νᵥₑₕ>0, a drive torque Tₜ>0 and the braking torque T_{brk}=0;
when the cotton picker decelerates, switching from the HEV hybrid drive mode C to the braking mode D, with the vehicle speed νᵥₑₕ>0, a drive torque Tₜ=0 and the braking torque T_{brk}=0;
when the cotton picker decelerates to a stop, switching from the brake mode D to the parking mode A, with the vehicle speed νᵥₑₕ=0, a drive torque Tₜ=0 and the braking torque T_{brk}=0.

The present disclosure achieves mechanical decoupling between various working systems of the cotton picker through distributed electric drive. During the operation of the cotton picker, the functions of motor drive, stepless speed regulation, and variable torque can be realized, making cotton-picking and packing work smoother, more efficient, and energy-saving, and improving the speed and transmission efficiency of the cotton picker.

In the parking mode A of the present disclosure, the entire machine stops working; in EV pure electric drive mode B, battery 28 drives the entire machine operation; in HEV hybrid drive mode C, the battery 28 and the engine 21 jointly drive the entire machine operation, and when the engine 21 has surplus power, it can drive the walking motor to charge battery 28 in reverse; in braking mode D, the wheels charge the battery 28 in reverse through the walking motor; in plug-in mode E, external power supply 29 of the series-parallel hybrid cotton picker charges the power battery 28. In the operation process of the series-parallel hybrid power cotton picker, the goal of switching between different modes of the parking mode A, the EV pure electric drive mode B, the HEV hybrid drive mode C, the braking mode D, and the plug-in mode E under hybrid operation of the cotton picker can be achieved, and the energy utilization efficiency can be improved, so that the range and energy saving of the whole machine can be balanced.

The present disclosure addresses the characteristics of high power and energy consumption of traditional combine harvesters, and adopts the series-parallel hybrid power technology to balance the overall range and energy saving of the machine. Compared with traditional power systems, the oil electric hybrid power system involves the coordinated output of dual power from the engine and the electric motor. The present disclosure switches between the parking mode, the EV pure electric drive mode, the HEV hybrid drive mode, the braking mode, and the plug-in mode according to specific operational requirements, providing greater flexibility and adaptability. The whole machine has the advantage of high energy utilization efficiency.

The cotton picker using the distributed electric drive technology in the present disclosure has the advantages of flexible structural layout and high energy utilization efficiency. As the part that directly generates power, there is no mechanical connection between the operating system and the power system, making it easy to achieve control decoupling between the two. The vehicle speed and the output torque can be frequently adjusted to match the continuous changes in actual load. Therefore, it has the advantages of stepless speed variation, variable output torque, and high transmission efficiency.

The series of detailed explanations listed above are only specific explanations of the feasible embodiments of the present disclosure, and they are not intended to limit the scope of protection of the present disclosure. Any equivalent embodiments or modifications that do not depart from the spirit of the present disclosure should be included within the scope of protection of the present disclosure.

What is claimed is:

1. A series-parallel hybrid power cotton picker, comprising a series-parallel hybrid power system; wherein the series-parallel hybrid power system comprises an engine, a gearbox, a coupling device, a differential, a generator, a battery, a main controller, a walking motor controller, a picking motor controller, a fan motor controller, a packing motor controller, a cotton collecting motor controller, and a conveyor motor controller; the engine and the battery are used for outputting power; the generator is used to convert mechanical energy of the engine into electrical energy to charge the battery; the battery is connected to the walking motor controller, and the battery distributes the electrical energy to the walking motor controller to control a walking motor to drive a walking device to move; the battery is connected to the picking motor controller to distribute the electrical energy to the picking motor controller, and the picking motor controller controls a picking motor to drive a picking device for picking; the battery is connected to the fan motor controller to distribute the electrical energy to the fan motor controller, and the fan motor controller controls a fan motor to drive a pneumatic conveying device for air supply; the battery is connected to the packing motor controller and distributes the electrical energy to the packing motor controller to control a packing motor for driving a packing device for packing; the battery is connected to a cotton collection motor controller, and the battery distributes the electrical energy to the cotton collection motor controller to control a motor for driving a striking roller to feed cotton into a cotton collection box; the battery is connected to the conveyor motor controller, and distributes the electrical energy to the conveyor motor controller to control a hydraulic pump motor for driving a wing plate of a cotton support frame; the engine is connected to the gearbox, and the gearbox is connected to the coupling device; the coupling device is connected to the walking motor, and the engine can transmit power to the coupling device through the gearbox; the coupling device couples the power of the engine and the walking motor, and then transmits the power to wheels through the differential;
the main controller is respectively connected to the battery, the walking motor controller, the picking motor controller, the fan motor controller, the packing motor controller, the cotton collection motor controller, and the conveyor motor controller.

2. The series-parallel hybrid power cotton picker according to claim 1, wherein the walking motor controller comprises a front axle motor controller and a rear axle motor controller; the walking motor includes a front axle motor and a rear axle motor;
the front axle motor controller is used to control the front axle motor to drive front wheels to move;
the rear axle motor controller is used to control the rear axle motor to drive rear wheels to move.

3. The series-parallel hybrid power cotton picker according to claim 1, wherein the picking device comprises a picking drum and a cotton removal drum; the picking motor is connected to a picking transmission shaft, and the picking transmission shaft is connected to the picking drum and the cotton removal drum through a transmission gear set; the picking motor drives the picking transmission shaft, and then transmits the power to the picking drum and the cotton removal drum through the transmission gear set.

4. The series-parallel hybrid power cotton picker according to claim 1, wherein a fan in the pneumatic conveying device is connected to the fan motor and driven separately by the fan motor.

5. The series-parallel hybrid power cotton picker according to claim 1, wherein the striking roller of a conveying and feeding system in the cotton collection box is connected to the motor and driven separately by the motor.

6. The series-parallel hybrid power cotton picker according to claim 1, wherein a film feeding roller and a transmission belt of a film covering device in the packing device share the packing motor; the film feeding roller is connected to the packing motor and directly driven by the packing motor; the transmission belt is connected to the packing motor through a belt and driven by the packing motor through the belt.

7. The series-parallel hybrid power cotton picker according to claim 1, wherein the battery is connected to the main controller through a step-down direct current to direct current (DC/DC) converter; the battery supplies power to the main controller after being stepped down by the step-down DC/DC converter.

8. The series-parallel hybrid power cotton picker according to claim 1, wherein a clutch is in front of the generator, and the generator switches the power input to the generator through the clutch.

9. The series-parallel hybrid power cotton picker according to claim 1, wherein an inverter is provided between the generator and the battery.

10. The series-parallel hybrid power cotton picker according to claim 1, wherein the series-parallel hybrid power system comprises a parking mode, an electric vehicle (EV) pure electric drive mode, a hybrid electric vehicle (HEV) hybrid drive mode, a braking mode, and a plug-in mode, and different modes can be switched according to different needs.

11. The series-parallel hybrid power cotton picker according to claim 10, wherein in the EV pure electric drive mode, the power is only provided to the walking motor through the battery.

12. The series-parallel hybrid power cotton picker according to claim 10, wherein in the HEV hybrid drive mode, when pure electric drive cannot meet target power, the battery and the engine work simultaneously; the power of the engine and the power of the walking motor driven by the battery are coupled through the coupling device and used to drive the wheels to walk through the differential; the clutch cuts off the power entering the generator and stops charging the battery.

13. The series-parallel hybrid power cotton picker according to claim 12, wherein in the HEV hybrid drive mode, when pure electric drive can meet the target power, the engine is connected to the generator to charge the battery.

14. The series-parallel hybrid power cotton picker according to claim 10, wherein in the braking mode, the wheels charge the battery in reverse through the walking motor.

15. The series-parallel hybrid power cotton picker according to claim 10, wherein in the plug-in mode, an external power source charges the battery of the series-parallel hybrid power cotton picker.

16. A control method for the series-parallel hybrid power cotton picker according to claim 1, wherein the control method comprises the following steps:
distributing the electrical energy by the battery of the series-parallel hybrid power system to the walking motor controller to control the walking motor and drive the walking device to move;
distributing the electrical energy by the battery to the picking motor controller to control the picking drum and the cotton removal drum of the picking device driven by the picking motor for picking; distributing the electrical energy by the battery to the fan motor controller to control the fan motor to drive the pneumatic conveying device separately for air supply; distributing the electrical energy by the battery to the packing motor controller to control the packing motor to drive the film feeding roller and the transmission belt of the packing device for packing; distributing the electrical energy by the battery to the cotton collection motor controller to control the motor to drive the striking roller separately to feed cotton into the cotton collection box; distributing the electrical energy by the battery to the conveyor motor controller to control the hydraulic pump motor to drive the wing plate of the cotton support frame;
adjusting a speed of the walking motor, the picking motor, the fan motor, the packing motor, the motor and the hydraulic pump motor through the walking motor controller, the picking motor controller, the fan motor controller, the packing motor controller, the cotton collection motor controller and the conveyor motor controller in the main controller.

17. The control method of the series-parallel hybrid power cotton picker according to claim 16, wherein the control method comprises the following steps:
providing power to the walking motor only by the battery when the series-parallel hybrid power system is in the EV pure electric drive mode;
in the HEV hybrid drive mode of the series-parallel hybrid power system, when pure electric drive cannot meet the target power, the battery and the engine are working simultaneously; coupling the output power of the engine and the walking motor driven by the battery by the coupling device and driving the wheels to walk by the differential; cutting off the power entering the generator by the clutch and stopping the engine charging the battery;
in the HEV hybrid driving mode of the series-parallel hybrid power system, when the pure electric drive can meet the target power, being connected to the generator by the engine to charge the battery;
in the braking mode of the series-parallel hybrid power system, charging the battery in reverse by the wheels through the walking motor;
in the plug-in mode of the series-parallel hybrid power system, charging the battery of the cotton picker by the external power source.

18. The control method of the series-parallel hybrid power cotton picker according to claim 17, wherein the control method comprises the following control steps of the series-parallel hybrid system:
when the cotton picker starts, switching from the parking mode to the EV pure electric drive mode, with the drive torque Tₜ>0 and a braking torque T_{brk}=0;
when the cotton picker decelerates, switching from the EV pure electric drive mode to the brake mode, with a vehicle speed νᵥₑₕ>0, a drive torque Tₜ=0 and the braking torque T_{brk}>0;
when the cotton picker accelerates, switching from the brake mode to the EV pure electric drive mode, with the vehicle speed νᵥₑₕ>0, the drive torque Tₜ>0, and the braking torque T_{brk}=0;
when the cotton picker decelerates, switching from the HEV hybrid drive mode to the EV pure electric drive mode, with the vehicle speed νᵥₑₕ<ν_{EV} a pure electric mode speed threshold, the drive torque Tₜ>0, the braking torque T_{brk}=0, and the battery state of charge (SOC)>a minimum battery capacity;
when the cotton picker continues to accelerate, switching from the EV pure electric drive mode to the HEV hybrid drive mode, with the vehicle speed νᵥₑₕ>V_{EV} a vehicle speed threshold in a pure electric mode, the drive torque Tₜ>0 and the braking torque T_{brk}=0;
when the cotton picker wheel drives the generator to charge the battery, with the vehicle speed νᵥₑₕ>0, the drive torque Tₜ=0, the braking torque T_{brk}≤T_{reg} a maximum regenerative braking torque of the motor, and the battery state of charge (SOC)<a maximum battery capacity;
when the cotton picker accelerates, switching from the brake mode to the HEV hybrid drive mode, with the vehicle speed νᵥₑₕ>0, the drive torque Tₜ>0, and the braking torque T_{brk}=0;
when the cotton picker decelerates, switching from the HEV hybrid drive mode to the braking mode, with the vehicle speed νᵥₑₕ>0, the drive torque Tₜ=0, and the braking torque T_{brk}>0;
when the cotton picker decelerates to a stop, switching from the brake mode to the parking mode, with the vehicle speed νᵥₑₕ=0, the drive torque Tₜ=0, and the braking torque T_{brk}=0.

19. The control method of the series-parallel hybrid power cotton picker according to claim 16, wherein in the series-parallel hybrid power cotton picker, the walking motor controller comprises a front axle motor controller and a rear axle motor controller; the walking motor includes a front axle motor and a rear axle motor;
the front axle motor controller is used to control the front axle motor to drive front wheels to move;
the rear axle motor controller is used to control the rear axle motor to drive rear wheels to move.

20. The control method of the series-parallel hybrid power cotton picker according to claim 16, wherein in the series-parallel hybrid power cotton picker, the picking device comprises a picking drum and a cotton removal drum; the picking motor is connected to a picking transmission shaft, and the picking transmission shaft is connected to the picking drum and the cotton removal drum through a transmission gear set; the picking motor drives the picking transmission shaft, and then transmits the power to the picking drum and the cotton removal drum through the transmission gear set.
